(19) United States
(12) Patent Application Publication
(10) Pub. No.: US 2013/0119207 A1
(43) Pub. Date: May 16, 2013

(54) Cable tool safety support

(71) Applicant: Timothy W. Troy, Evanston, WY (US)

(72) Inventor: Timothy W. Troy, Evanston, WY (US)

(73) Assignee: Pro Wireline, Inc., Evanston, WY (US)

(21) Appl. No.: 13/373,407

(22) Filed: Nov. 14, 2011

(51) Int. Cl. F16L 3/02; B23P 11/00

(52) U.S. Cl. 248/59; 248/58; 29/428

(57) ABSTRACT

A cable tool safety tripod platform upon which the end of the cable tool is supported during removal and interchanging of different cable drilling tools.

### BACKGROUND OF THE INVENTION

1. Field

This invention relates to cable percussion drilling and cased hole wire line cable services using a string of tools suspended from a cable. In particular it relates to a cable tool safety support upon which the end of a cable tool is supported and secured during removal and interchanging of different tools.

2. State of the Art

Suspended cable tools are used for various down hole activities. Cable drilling is a method of drilling used primarily for shallow depths whereby an impact tool or bit is suspended in a well from a steel cable and is dropped repeatedly on the bottom of the hole to crush the rock and open a formation a geological formation for liquids to flow into the hole.

Typically, a truck with a crane suspends a drum cable, which is alternatively lifted and dropped for a cable tool attached to the end of the cable to impact the bottom of the hole. These cable tool drill rigs typically have the following components:

A drilling cable for lifting and turning tools, as well as controlling the motion of the tools.

A swivel socket to connect the cable to the tools and enable the cable to unwind.

A drill stem that provides weight and guides the bit in the direction of the desired drilling.

A drill bit for penetrating and crushing rock.

A driving case, where the force of a clamp is used to drive in the casing to protect the well bore.

A drilling jar that keeps the tools from jamming together.

A shock absorber, which rebounds the tools off the rock when it finishes striking the rock surface.

Cable drill rigs raise and drop a drill string usually with a heavy carbide tipped drilling bit that chisels through the rock by finely pulverizing the subsurface materials. The drill string is composed of the upper drill rods, a set of “jars” (inter-locking “sliders” that help transmit additional energy to the drill bit and assist in removing the bit if it is stuck) and the drill bit. During the drilling process, the drill string is periodically removed from the borehole and a bailer is lowered to collect the drill cuttings (rock fragments, soil, etc.). The bailer is a bucket-like tool with a trapdoor in the base. If the borehole is dry, water is added so that the drill cuttings will flow into the bailer. When lifted, a bailer trapdoor closes holding the cuttings, which are then raised to the surface and removed. Since the drill string must be raised and lowered to advance the boring, the casing (larger diameter outer piping) is typically used to hold back upper soil materials and stabilize the borehole. After a few impacts on the bottom of the hole, the cable is reeled in and the cuttings basket emptied, or a bailer is used to remove cuttings from the well. The tool is reeled back to the bottom of the hole and the process repeated.

Other wire line cable tools suspended from the crane of a truck with a drum cable are used for cased holes to optimize oil production from a previously bored well. Various tools are suspended from a cable wire and lowered at various levels within an existing well to generate information to help understand both the well and the reservoir to optimize lifetime production. This data determines if obstructions should be removed, or engineered perforating may be required. Different string cable tools are used to measure pressure, flow, phase production and for cross-well cased hole logging, as well as integrity evaluation to insure wells continue to reach full their production potential, year in and year out.

Some of these tools monitor fluid distribution and movement in the reservoir with tools such as the DeepLook-EM enhanced cross well reservoir monitoring system. They further track fluid fronts and identify bypassed pay from reservoir-scale resistivity images. Multi-frequency measurements made radially at multiple depths via scanners and cased hole logging under any conditions find and optimize reservoir management with ABC analysis behind casing using isolation scanners, flow scanners, EM pipe scanners, cased hole dynamics testers, cased hole formation resistivity tools, etc.

Other perforating tools break up formations at specific levels for better production formation flows. Comprehensive production logging of this flow information insures optimum reservoir management with ABC analysis behind the casing as well as comprehensive profiles of down hole flow from three-phase oil/gas/water flow environments using flow scanners, PS Platform, MaxTRAC, and cement evaluation using noninvasifely measured bonds between the casing and cement with acoustic sonic and ultrasonic tools. Other tools monitor and evaluate corrosion via casing inspection using acoustic, electrical and mechanical scanners and imagers.

Still other wireline tools set plugs and packers for wireline operations at different levels in deep and highly deviated wells with integrated deployment systems. Thus a wide variety of different tools are required to optimize down hole oil production by providing direct physical measurements of the interwell space enabling numerous reservoir characterization fluid-front monitoring applications to manage operations, and borehole imaging. These cable tools may also include continuous flow meter (spinner), temperature, pressure, collar locator, and optional gamma ray sensors, which provide delta pressure calculations for fluid identification

These different cased hole suspended cable tools are secured to different types of rope sockets attached to the end of the cable, which have a threaded end to which additional stems, jars, shock absorbers, swivel joints, chisels, broaches, tubing gauge cutters, etc. are attached or formed into an equipment string to perform a required function. The equipment string is therefore periodically interchanged with different cable tools at the surface as needed for production management and logging.

Under current OSHA regulations a three man crew is required to interchange suspended cable tools—one to operate a truck with a crane, one to change out the tool from the suspended cable, and one to steady the cable during tool change over.

The device described below provides a support base for the wire line lubricator and tool string thus allowing the tools to be interchanged; thereby eliminating the suspended load of the lubricator during tool change over, and the need for a third man, and providing a safe work area while changing out tools.

### SUMMARY OF THE INVENTION

The invention comprising a cable tool safety support having a base with an underside and a central bore structured to accommodate and removably secure strings of cable tools inserted within the central bore for temporary suspension under the base. A threaded top bore union is generally affixed on the base in alignment with the central bore structured to removably secure to the spindle or rope socket of the suspended cable, when not affixed to a string of cable tools to be inserted within the central bore to prevent the end of the cable with tools attached from swinging.

In one embodiment, a collar surrounds the underside of the base bore with its center hole in alignment. Three securing screws equilaterally positioned there around are structured when tightened to pass into the interior of the center hole to removably secure a suspended tool from the collar.

Three legs with top ends and bottom ends have their top ends attached equally spaced apart to the underside of the base to form a tripod when the bottom ends are spread apart. Equal length securing means, such as chains, ropes, cables, etc. are attached to the bottom ends of the legs to form a secure triangular tripod base when spread to contact a support surface.

The height and structure of the legs is selected to suspend the weight of the cable tools underneath the base for tool interchange. Typically these three legs telescope from 6 feet to 10 feet in length and are adjustable in height to accommodate the type of tool, drill casing, or extractor required. One telescoping leg embodiment comprises two first and second nesting sections of sufficiently thick gauge aluminum square tubing, which will support approximately 700 pounds, when placed in position. The first top nesting sections have a series of holes, which align with the top hole of the second bottom nesting sections and are secured when aligned at the desired height with a removable pin.

The bottoms of the second bottom nesting section may include a foot to spread pressure onto a wider base of support. These feet may be adjustably mounted to the bottoms of the second bottom nesting sections to accommodate irregular support surfaces, terrain, or ground.

Although aluminum is preferred, any light weight strong material may be used for the safety tool construction.

The top ends of the three legs may be hingedly attached to the underside of the base to store together in one mode for transport and spread apart to form a tripod in the other mode when in use.

The cable tool safety method for interchanging cable tools suspended from a cable in and out of a bore hole comprises installing beneath the end of a suspended cable tool near a bore hole a cable tool safety support to removably secure the string of cable tools while interchanging different cable tools. After the combination of the string of cable tools is adjusted, the cable string is released from the cable tool safety support for re-entry into the cased bore. This process is repeated until a well is completed or cased well management work is completed.

If it is necessary to remove the entire string of cable tools, the base of the cable rope socket may temporarily be removably affixed to the cable tool safety support by threading it to a top union to secure the end of the cable from swinging and injuring workers. It is then released and reconnected to the new string of cable tools after assembly.

As the end of the cable tool is secured during the cable tool exchange process, there is no need for a third man to steady the cable end for safety. Consequently, not only is safety maintained, but significant labor savings result.

### DESCRIPTION OF THE DRAWINGS

FIG. 1 is a perspective view of one embodiment of the invention.

FIG. 2 is a top view of the embodiment of FIG. 1.

FIG. 3 is a bottom view of the embodiment of FIG. 1 without legs.

### DESCRIPTION OF THE ILLUSTRATED EMBODIMENTS

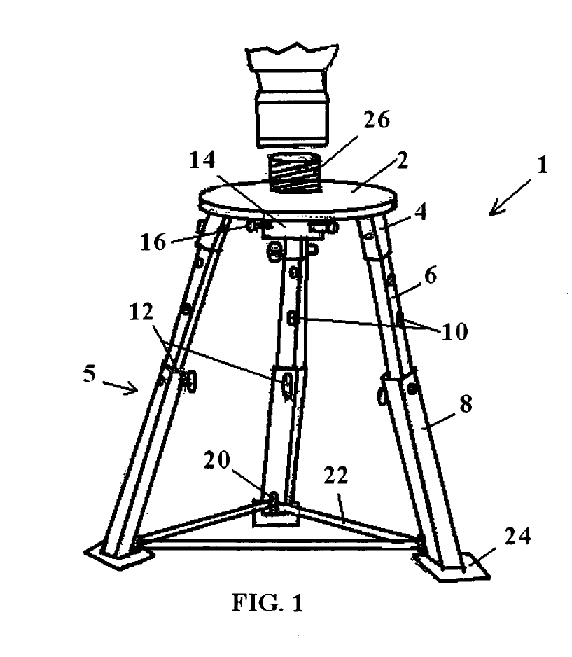

FIG. 1 is a perspective view of one embodiment of the invention. The invention 1 comprising a cable tool safety support having a base 2 with an underside and a central bore 3 structured to accommodate and removably secure strings of cable tools inserted within the central bore 3 for temporary storage and suspension under the base 2.

Three telescoping legs 5 with top ends 4 and bottom ends 8 have their top ends 4 attached equally spaced apart to the underside of the base 2 to form a tripod support when the leg 5 bottom ends 8 are spread apart. The legs 5 have a telescoping segment 6 with a plurality of holes, which are secured by removable pins 12 affixed to the bottom ends 8 at the desired height.

A collar 14 surrounds the underside of the base 2 bore 3 with its center hole 9 in alignment with the bore 3. Three securing screws 16 equilaterally positioned there around are structured when tightened to pass into the interior of the center hole 9 to removably secure a suspended tool from the collar 14.

The height and structure of the legs 5 is selected to suspend the weight of the cable tools underneath the base for tool interchange. Typically these three legs telescope from 6 feet to 10 feet in length and are adjustable in height to accommodate the type of tool, drill casing, or extractor required. The telescoping leg 5 embodiment shown is made of nesting 3/16 inch wall thickness aluminum 2½″ square tubing, or ¼ inch wall thickness 2″ square tubing, which will support approximately 700 pounds, when placed in position.

The bottoms of the legs 5 may include feet 24 to spread pressure onto a wider base of support. These feet 24 may be adjustably mounted to the bottoms of the legs 5 to accommodate irregular support surfaces, terrain, or ground.

Although aluminum is preferred for its light weight and strength, any light weight strong material may be used for the safety tool construction.

The top ends 4 of the three legs 5 are attached with screw in brackets 28 shown in FIG. 3 to the underside of the base 2 for removal in one mode for storage and spread apart to form a tripod in the other mode when in use. Equal length securing means, such as chains, ropes, cables, etc. 22 are attached to the bottom ends of the legs 5 via eyes 20 to form a secure triangular tripod base when spread to contact a support surface.

A threaded top bore union 26 is generally affixed on the base 2 in alignment with the central bore and structured to removably secure to the spindle or rope socket of the suspended cable, when not affixed to cable tools to prevent the end of the cable from swinging.

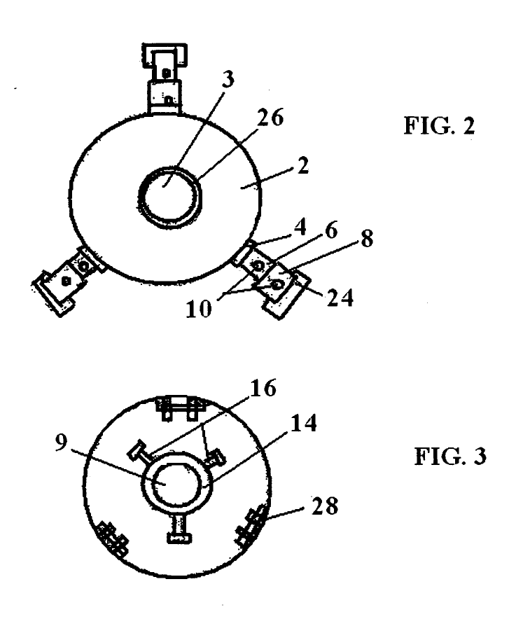

FIG. 2 is a top view of the embodiment of FIG. 1 showing the central bore 3.

FIG. 3 is a bottom view of the embodiment of FIG. 1 without legs 5 showing the collar center bore 9 in alignment with the bore 3 of the base 2.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. A cable tool safety support comprising:
a. a base with an underside defining a center bore structured to accommodate and removably secure cable tools placed therein for suspension extending under the base during tool interchange in one mode, and to release the cable tools for insertion into a bore hole of a well in another mode; and
b. three legs with top ends and bottom ends equally spaced apart and attached to the base underside to form a tripod when spread apart.
the height and structure of the legs selected to suspend the weight of the cable tools underneath the base during cable tool interchange.

2. A cable tool safety support according to claim 1, including equilateral securing means attached to the bottom ends of the legs to form a secure triangular base to prevent the legs from spreading when contacting a support surface.

3. A cable tool safety support according to claim 1, including a threaded top bore union affixed to the base structured to removably secure an end of a rope socket when not affixed to cable tools to prevent free cable swinging.

4. A cable tool safety support according to claim 1, wherein the three legs are extendable telescoping tubes with locking means to secure them at a desired length.

5. A cable tool safety support according to claim 4, wherein the top ends of the three legs are hingedly attached to the underside of the base to store together in one mode and spread apart to form a tripod in the other mode.

6. A cable tool safety support according to claim 1, wherein the legs are constructed of light weight materials of sufficient strength to support the weight of a string of cable tools.

7. A cable tool safety method for interchanging cable tools suspended from a cable in and out of a bore hole comprising:
a. installing beneath the end of a suspended cable tool near a bore hole a cable tool safety support with:
i. a base with an underside defining a bore structured to accommodate and removably secure cable tools placed therein for suspension under the base; and
ii. three legs with top ends and bottom ends equally spaced apart and attached to the base underside to form a tripod when spread apart;
the height and structure of the legs selected to support the weight of the cable tools suspended underneath the base for tool interchange.
b. removably securing the suspended cable tool to the base to suspend the cable tool under the base;
c. removing and exchanging the cable tools with other cable tools forming a new cable tool combination for attachment to the end of the cable,
d. releasing the new cable tool combination from the base bore for insertion into the bore hole, and
e. repeating steps b through d, as needed.

8. A cable tool safety method for interchanging cable tools suspended from a cable according to claim 7, including equilateral securing means attached to the bottom ends of the legs to form a secure triangular base contact support surface.

9. A cable tool safety method for interchanging cable tools suspended from a cable according to claim 7, including a threaded top bore union affixed to the base structured to removably secure an end of a rope socket when not affixed to cable tools to prevent cable swinging.

10. A cable tool safety method for interchanging cable tools suspended from a cable according to claim 7, wherein the top ends of the three legs are hingedly attached to the underside of the base to store together in one mode and spread apart to form a tripod in the other mode.
